(19) United States
(12) Patent Application Publication
(10) Pub. No.: US 2015/0364065 A1
(43) Pub. Date: Dec. 17, 2015

(54) FLEXIBLE DISPLAY DEVICE

(71) Applicant: BOE Technology Group Co., Ltd., Beijing (CN)

(72) Inventors: Xiangxiang ZOU, Beijing (CN); Jiayang ZHAO, Beijing (CN); Yuanbo ZHANG, Beijing (CN); Wei QIN, Beijing (CN)

(21) Appl. No.: 14/396,627

(22) PCT Filed: Dec. 12, 2013
(86) PCT No.: PCT/CN2013/089297

§ 371 Date: Oct. 23, 2014

(30) Foreign Application Priority Data
Jul. 1, 2013 (CN) 201310272006.X

(51) Int. Cl. G09F 9/30

(52) U.S. Cl. CPC G09F 9/301

(57) ABSTRACT

A flexible display device includes a flexible display screen (40), a roller (30), a driving system (50) and a roller guide structure (20). The roller (30) is mounted on the roller guide structure (20), the driving system (50) is configured for driving the roller (30) to move along the roller guide structure (20). The roller (30) comprises a spiral structure (31) having an accommodating channel, and the flexible display screen (40) is moved into or out of the accommodating channel while the roller (30) moves along the roller guide structure (20).

### TECHNICAL FIELD

Embodiments of the invention relate to a flexible display device.

### BACKGROUND

A flexible display device typically comprises a working platform 1, and a flexible display screen 4, a roller 3, a movable guide rail 2 and a control board 5 provided on the working platform 1. The roller 3 is mounted on the movable guide rail 2, and the control board 5 controls the roller 3 to make reciprocating motion along the movable guide rail 2. In a conventional flexible display device, it is necessary to connect the flexible display screen 4 and the roller 3, the roller being a disc type. As illustrated in FIG. 1 and FIG. 2, an end of the flexible display screen is typically connected to an edge of the roller with an adhesive tape 6 or rope 7, so that the flexible display screen is driven to wind or spread around the roller during the roller's rotation. The position for connecting the flexible display screen 4 and the roller 3 needs to be reserved in advance. Moreover, the connection is easy to be damaged in operation, which renders the flexible display device unusable and difficult to repair after damage, thereby greatly reducing the life time of the flexible display device.

### SUMMARY OF THE INVENTION

An embodiment of the invention provides a flexible display device, comprising a flexible display screen, a roller, a driving system and a roller guide structure, the roller being mounted on the roller guide structure, the driving system being configured for driving the roller to move along the roller guide structure, wherein the roller comprises a spiral structure with an accommodating channel, and the flexible display screen is moved into or out of the accommodating channel while the roller is moved along the roller guide structure.

In one example, the roller makes reciprocating motion along the roller guide structure in a disposition direction of the flexible display screen.

In one example, the roller is made of a transparent material.

In one example, the flexible display device further comprises a working platform, on which the flexible display screen, the roller, the driving system and the roller guide structure are disposed.

In one example, in a state where the flexible display screen is completely moved out of the spiral structure of the roller, one end of the flexible display screen is located at an outer opening of the spiral structure of the roller.

In one example, the roller guide structure is a movable guide rail, the driving system is a control board, the roller is mounted on the movable guide rail, and the control board controls the roller to make reciprocating motion along the movable guide rail.

In one example, the roller is made of a polycarbonate material or an acrylic material.

In one example, the spiral structure of the roller comprises one or more spiral rings.

In one example, the accommodating channel of the roller has a substantially uniform width.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a structural schematic diagram of a conventional flexible display device;

FIG. 2 is a structural schematic diagram of another conventional flexible display device;

FIG. 3 is a structural schematic diagram of a flexible display device according to an embodiment of the invention;

FIG. 4 is a structural schematic diagram of a roller according to an embodiment of the invention.

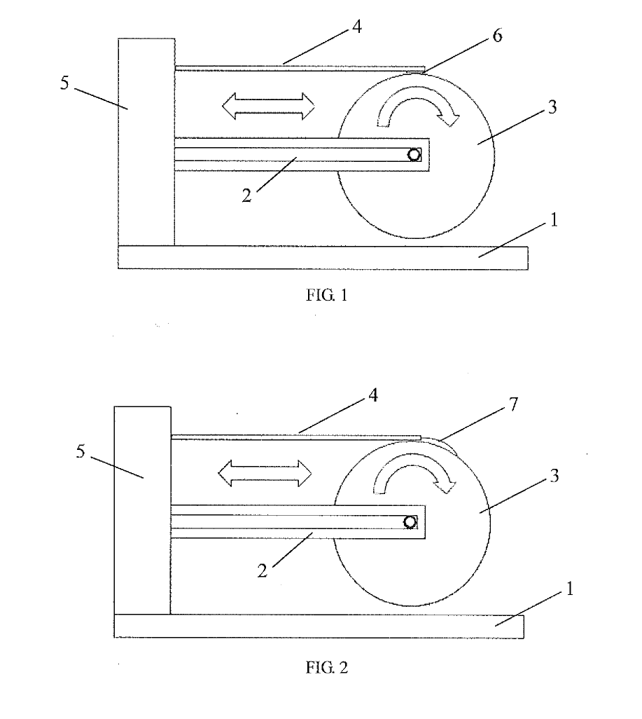

### DESCRIPTION OF THE EMBODIMENTS

Below, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

A technical problem to be solved by the invention is to provide a flexible display device which does not need to connect the flexible display screen with the roller, so as to increase the life time of the flexible display device.

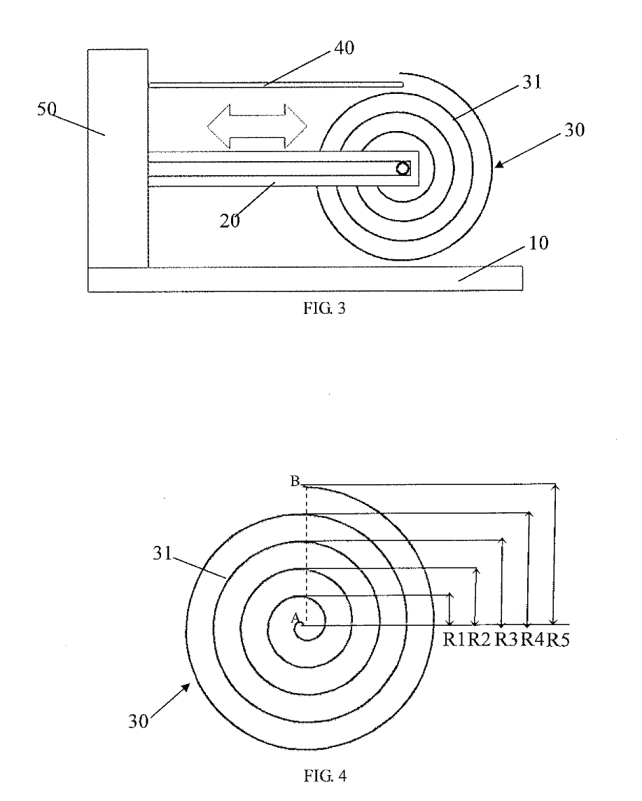

As illustrated in FIG. 3, a flexible display device according to an embodiment of the invention, comprises a flexible display screen 40, a roller 30, a driving system 50, and a roller guide structure 20. The roller 30 is mounted on the roller guide structure 20, and the driving system 50, for example, drives the roller 30 to move along the roller guide structure 20. The roller 30 comprises a spiral structure 31 which has a channel for accommodating the flexible display screen 40. When the roller 30 moves along the roller guide structure 20, the flexible display screen 40 moves into or out of the accommodating channel. The spiral structure 31, for example, has an outer opening far away from the center thereof and an inner opening close to the center thereof.

The roller 30 makes reciprocating motion along the roller guide structure 20 in a direction in which the flexible display screen 40 is disposed. The disposition direction of the flexible display screen 40 may be a horizontal direction, a vertical direction or an oblique direction. FIG. 3 illustrates the flexible display screen 40 disposed in the horizontal direction. The roller 30 also makes reciprocating motion along the horizontal direction, so that the flexible display screen 40 moves into or out of the spiral structure 31 of the roller.

Referring to FIG. 3, the roller 30, for example, is movably mounted on the roller guide structure 20 at the inner opening thereof. In a state where the flexible display screen 40 is completely moved out of the spiral structure 31 of the roller 30, one end of the flexible display screen 40 is located at the outer opening of the spiral structure 31 of the roller 30. At this time, the end of the flexible display screen 40 is in contact with an opening of an external spiral ring in the spiral structure 31, and stably disposed at the opening, so that when the roller makes reciprocating motion along a direction in which the flexible display screen is disposed, the flexible display screen 40 is moved into or out of the spiral structure 31 of the roller 30 smoothly. It can be conceived that in a state where the flexible display screen 40 is completely moved out of the spiral structure 31 of the roller, the end of the flexible display screen 40 may also located at any arbitrary opening in the spiral structure 31, as long as the opening allows the flexible display screen 40 to be moved into or out of the spiral structure 31 of the roller 30.

In one example, the roller 30 is made of a transparent material.

In another example, the flexible display device according to the present embodiment further comprises a working platform 10, on which a flexible display screen 40, a roller 30, a driving system 50, and a roller guide structure 20 are disposed.

The roller guide structure may be a movable guide rail 20, the driving system may be a control board 50. The roller 30 is mounted on the movable guide rail 20, and the control board 50 controls the roller to make reciprocating motion along the movable guide rail 20.

As illustrated in FIG. 3, when the roller 30 moves to the left along the movable guide rail 20, the flexible display screen 40 enters the spiral structure 31 of the roller 30 and curves; when the roller 30 moves to the right along the movable guide rail 20, the flexible display screen 40 moved out of the roller 30.

In case the flexible display screen 40 enters into the spiral structure 31 of the roller 31, an image displayed on the flexible display screen 40 can be seen, thus a preliminary evaluation of the bent display starts to be test.

In one example, the roller 30 is made of a transparent material such as a polycarbonate material or an acrylic material, which are transparent and not easily deformed.

The spiral structure 31 of the roller 30 may comprise one or more spiral rings. When the spiral structure 31 comprises a plurality of spiral rings, the plurality of spiral rings are connected head-to-tail sequentially to form the channel for accommodating the flexible display screen. Since radius of curvature of the spiral ring of the roller gradually decrease from the outside to the inside, when the flexible display screen enters into the channel formed by the spiral ring, the deeper it enters, the greater the curve degree of the display screen; therefore, a reliability test can be performed on the curving situation of the flexible display screen.

In one example, intervals between any two adjacent spiral rings are equal to one another, so that the accommodating channel of the roller has a substantially uniform width, to avoid deformation of relatively great difference caused by different intervals, which easily damages the display screen.

The embodiment of the invention takes the spiral structure 31 consisting of five spiral rings as an example. As illustrated in FIG. 4, the five spiral rings, for example, is delimited by a spiral line which starts at terminal A and ends at terminal B of the spiral structure 31 (the dashed line in FIG. 4). The radii of the five spiral rings R1, R2, R3, R4, and R5 are 10 mm, 20 mm, 30 mm, 40 mm and 50 mm, respective.

The flexible display device according to the embodiments of the invention adopts a roller of a spiral structure, and the flexible display screen does not have a connection relationship with the roller, thereby reducing the damage to the flexible display screen and increasing the life time of the flexible display device. The flexible display screen can be moved into or out of the spiral structure of the roller and display images while the roller moves. Moreover, a curve degree test and a reliability test may be performed for the flexible display screen while the flexible display screen enters into the spiral structure.

Although the invention has been described above in detail with general explanation and specific embodiment, it is obvious to those skilled in the art to make some modifications or improvements thereto on the basis of the invention. Therefore, these modifications or improvements without departing from the spirit of the invention all belong to the protection scope claimed by the invention.

1. A flexible display device, comprising a flexible display screen, a roller, a driving system and a roller guide structure, the roller being mounted on the roller guide structure, the driving system being configured for driving the roller to move along the roller guide structure, wherein the roller comprises a spiral structure with an accommodating channel, and the flexible display screen is moved into or out of the accommodating channel while the roller is moved along the roller guide structure.

2. The flexible display device according to claim 1, wherein the roller makes reciprocating motion along the roller guide structure in a disposition direction of the flexible display screen.

3. The flexible display device according to claim 1, wherein the roller is made of a transparent material.

4. The flexible display device according to claim 1, further comprising a working platform, on which the flexible display screen, the roller, the driving system and the roller guide structure are disposed.

5. The flexible display device according to claim 1, wherein in a state where the flexible display screen is completely moved out of the spiral structure of the roller, one end of the flexible display screen is located at an outer opening of the spiral structure of the roller.

6. The flexible display device according to claim 1, wherein the roller guide structure is a movable guide rail, the driving system is a control board, the roller is mounted on the movable guide rail, and the control board controls the roller to make reciprocating motion along the movable guide rail.

7. The flexible display device according to claim 1, wherein the roller is made of a polycarbonate material or an acrylic material.

8. The flexible display device according to claim 1, wherein the spiral structure of the roller comprises one or more spiral rings.

9. The flexible display device according to claim 1, wherein the accommodating channel of the roller has a substantially uniform width.

10. The flexible display device according to claim 2, wherein the roller is made of a transparent material.

11. The flexible display device according to claim 2, further comprising a working platform, on which the flexible display screen, the roller, the driving system and the roller guide structure are disposed.

12. The flexible display device according to claim 3, further comprising a working platform, on which the flexible display screen, the roller, the driving system and the roller guide structure are disposed.

13. The flexible display device according to claim 2, wherein in a state where the flexible display screen is completely moved out of the spiral structure of the roller, one end of the flexible display screen is located at an outer opening of the spiral structure of the roller.

14. The flexible display device according to claim 3, wherein in a state where the flexible display screen is completely moved out of the spiral structure of the roller, one end of the flexible display screen is located at an outer opening of the spiral structure of the roller.

15. The flexible display device according to claim 4, wherein in a state where the flexible display screen is completely moved out of the spiral structure of the roller, one end of the flexible display screen is located at an outer opening of the spiral structure of the roller.

16. The flexible display device according to claim 2, wherein the roller guide structure is a movable guide rail, the driving system is a control board, the roller is mounted on the movable guide rail, and the control board controls the roller to make reciprocating motion along the movable guide rail.

17. The flexible display device according to claim 3, wherein the roller guide structure is a movable guide rail, the driving system is a control board, the roller is mounted on the movable guide rail, and the control board controls the roller to make reciprocating motion along the movable guide rail.

18. The flexible display device according to claim 4, wherein the roller guide structure is a movable guide rail, the driving system is a control board, the roller is mounted on the movable guide rail, and the control board controls the roller to make reciprocating motion along the movable guide rail.

19. The flexible display device according to claim 5, wherein the roller guide structure is a movable guide rail, the driving system is a control board, the roller is mounted on the movable guide rail, and the control board controls the roller to make reciprocating motion along the movable guide rail.

20. The flexible display device according to claim 2, wherein the roller is made of a polycarbonate material or an acrylic material.
